(19) United States
(12) Patent Application Publication
(10) Pub. No.: US 2005/0102451 A1
(43) Pub. Date: May 12, 2005

(54) Programmable wireless receiver

(75) Inventors: Chi-Chuan Pan, Jhonghe City (TW); Hui-Chi Chang, Lujhou City (TW)

Correspondence Address: ARENT FOX KINTNER PLOTKIN & KAHN, PLLC, 1050 Connecticut Avenue, N.W., Suite 400, Washington, DC, 20036-5339, US

(73) Assignee: CHICONY ELECTRONICS CO. LTD

(21) Appl. No.: 10/701,424

(22) Filed: Nov. 6, 2003

(51) Int. Cl. G06F 3/00

(52) U.S. Cl. 710/62

(57) ABSTRACT

A programmable wireless receiver capable of expanding the number of peripherals by using software and command programmers. It also supports peripherals of various computer systems. In addition, the receiver dynamically changes and/or expand the system peripherals according to user's needs. The programmable receiver features a command storage medium capable of repeatedly saving and/or setting the corresponding commands of peripherals in such command storage medium through a command programmer. Such commands are then executed by the programmable receiver in accordance with drivers, thus enabling the user to have access to various receiving interfaces so as to reduce the hardware consumption of the host computer.

### BACKGROUND OF THE INVENTION

1. Field of the Invention

The present invention relates to a programmable wireless receiver, more particularly, a programmable wireless receiver capable of reducing IC consumption and allowing the computer system to support various peripherals at the same time.

2. Description of the Related Art

Wireless peripherals (such as wireless mice and wireless keyboards) are regarded as standard accessories for the purpose of executing commands or inputting data in the current computer systems, such as portable computers. FIGS. 1 and 2 show the first and second schematic drawings of computer peripherals of the conventional wireless communication respectively. As shown in FIGS. 1 and 2, a wireless keyboard 1, a wireless mouse 2, and a wireless remote control 3 are connected to a host computer 11 with separate cables. When a user intends to transmit a controlling signal via the wireless keyboard 1, the wireless mouse 2, and the wireless remote control 3, the controlling signal will be input into the host computer 11 via the cables 6.

A receiver 5 requires a receiving circuit for receiving controlling signals transmitted from the wireless devices to an IC (not shown in these drawings) for further decoding so as to determine the exact peripheral accessory wherefrom such controlling signals were transmitted. Then such signals are transmitted to the host computer 11 via the interface of the wireless peripheral, and the command is executed in accordance with drivers.

FIG. 3 shows the third schematic drawing of computer peripherals of the conventional wireless communication. As shown in FIG. 3, a multi-functional receiver socket 7 is used as the transmitting interface between the receiver 5 and the IC. The multi-functional receiver socket 7 serves the functions of sockets for peripherals such as keyboards, mice and multimedia receivers, whereby the controlling signals of the aforesaid wireless peripherals can be transmitted to a built-in IC of the host computer 31 via the multi-functional receiver socket 7 for further interpretation so as to reduce the number of cables 6.

### SUMMARY OF THE INVENTION

With regard to related art, when user intends to execute commands or input data through the computer peripherals, there is still a need for a receiving circuit and IC to receive and interpret the controlling signals transmitted by these peripherals. However, each peripheral needs a receiver and each receiver requires a fixed number of supporting circuits in the system. The expansion of computer peripherals thus will lead to the modification of circuit and the increase of cost. In addition, the complicated installation procedure may also cause users inconvenience in operation and a waste of time.

Hence the object of the present invention is to provide a programmable wireless receiver in accordance with a programmer and software to change the receiving mode of the peripherals so that the user could dynamically change and/or expand the receiving module of peripherals.

Another object of the present invention is to provide a programmable wireless receiver so that user may expand the receiving module of the peripherals through the software without modifying or expanding the IC.

Another object of the present invention is to provide a programmable wireless receiver so that the computer user can choose among the receiving modules of various peripherals without changing the hardware circuit.

Another object of the present invention is to provide a programmable wireless receiver so as to provide the user with the receiving modules of various peripherals without occupying the memory, storage devices, or CPU of the host.

The present invention provides a programmable wireless receiver incorporated with a program circuit comprising a microprocessor and a storage medium so as to enable the user to use the software-stimulation programmer to enter programming commands of computer peripherals Then the programming commands will be saved in the storage medium so as to enhance the expandability and convenience of the receiving mode obtained by the user.

According to the preferred embodiment of the present invention, the programmable wireless receiver in the present invention may set and/or expand its receiving mode through a software-stimulation programmer. The receiver comprises a microprocessor to receive and execute the programming commands input by the programmer, and a memory connected to the microprocessor as a medium for accessing the programming commands.

The memory is an Erasable Programmable Read Only Memory (EPROM).

The programming commands correspond to the receiving modes of the peripherals.

The input interface of the programmer and the receiver is a Universal Serial Bus (USB).

The peripherals are wireless keyboards, wireless mice, or wireless remote controls.

The programmer and the receiver also comprise a user interface to switch among receiving modes of various peripherals.

### BRIEF DESCRIPTION OF THE DRAWINGS

These and other features, aspects and advantages of the present invention will become better understood with regard to the following description, appended claims and accompanying drawings that are provided only for further elaboration without limiting or restricting the present invention, where:

FIG. 1 is the first schematic diagram of computer peripherals in the conventional wireless communication.

FIG. 2 is the second schematic diagram of computer peripherals in the conventional wireless communication.

FIG. 3 is the third schematic diagram of computer peripherals in the conventional wireless communication.

FIG. 4 is a block diagram showing the embodiment of the programmable wireless receiver of the present invention.

FIG. 5 is a flow chart showing the embodiment of the programmable wireless receiver of the present invention.

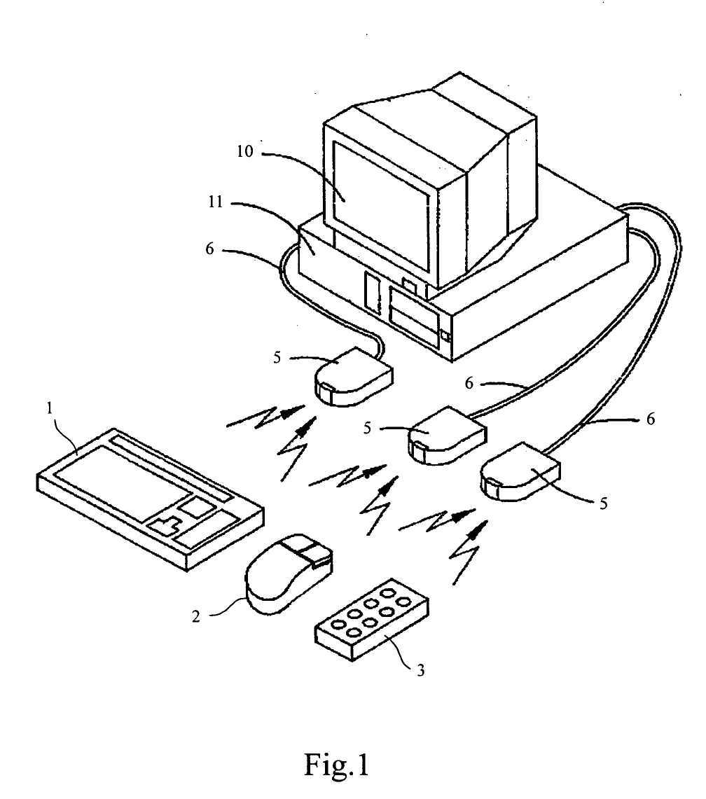

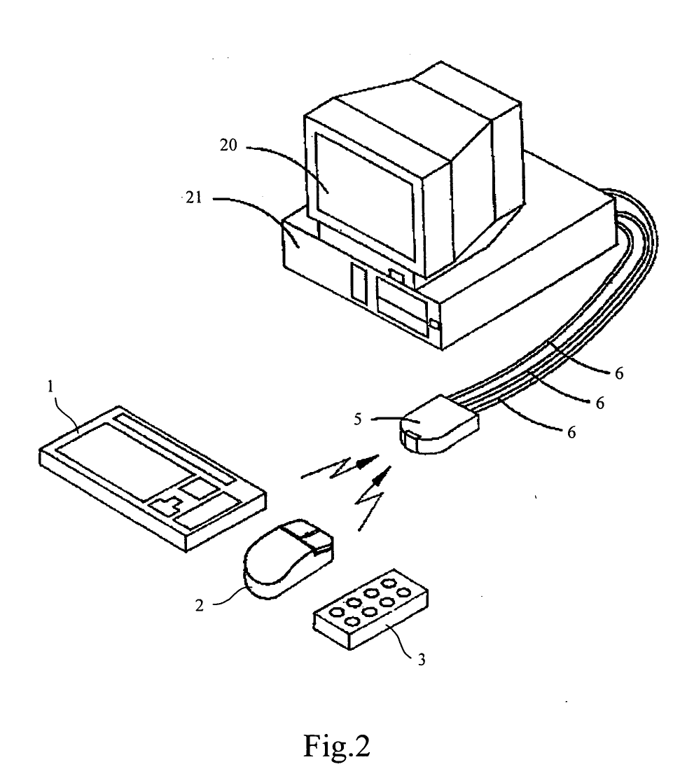

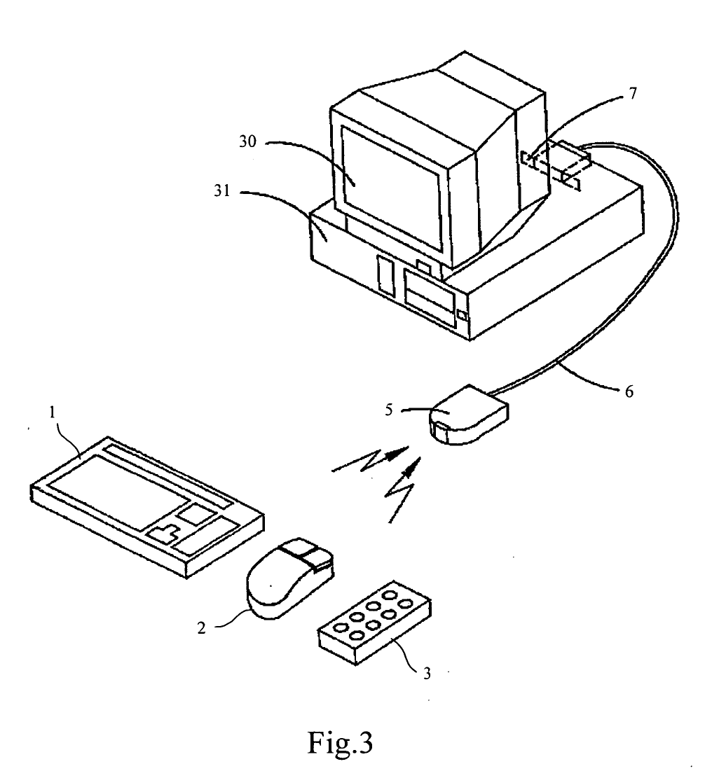

### DETAILED DESCRIPTION OF THE PREFERRED EMBODIMENT

The following is a detailed description of the best presently known modes of carrying out the inventions. This description is not to be taken in a limiting sense, but is made merely for the purpose of illustrating the general principles of the inventions.

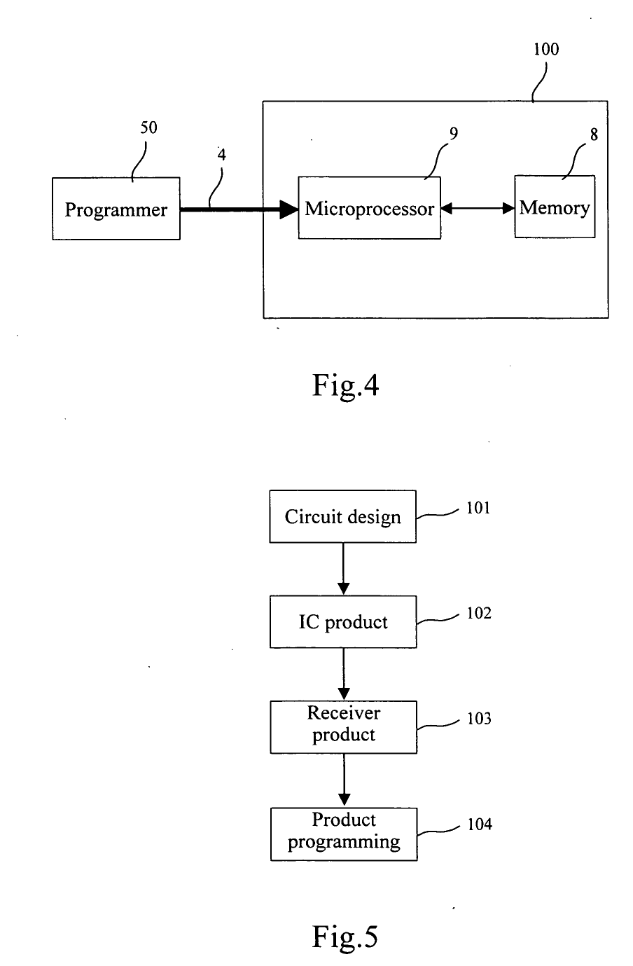

Referring to FIG. 4, a block diagram shows the embodiment of the programmable wireless receiver of the present invention. As shown in FIG. 4, the programmable wireless receiver of the present invention comprises a microprocessor 9 and a memory 8 so as to enable the user to set the programming commands corresponding to the computer peripherals in the receiver 100 via a software-stimulation programmer 50. Then the programming commands are saved in the memory 8 so as to enhance the expandability and convenience of the peripheral receiving mode obtained by the user.

Also referring to FIG. 4, according to the preferred embodiment of the present invention, the programmable wireless receiver in the present invention 100 may set and/or expand the receiving mode of the receiver 100 through a software-stimulation programmer 50. The receiver comprises a microprocessor 9 to receive and execute the programming commands input by the programmer 50, and a memory connected to the microprocessor 9 as a medium for accessing the programming commands.

The memory 8 is an EPROM, and the input interface of the programmer 50 and the receiver 100 is a USB 4.

The wireless receiver 100 may show an onscreen display menu to help user switch among the receiving modes of various peripherals.

FIG. 5 shows the embodiment of the programmable wireless receiver of the present invention. Please see also FIG. 4. As shown in FIG. 5, in the general process of receiver production, the first step is to finish the circuit design 101 of the IC. The circuit design procedure includes the complete description of the function, and the IC must go through the validity test after the production process to make sure that the chip does not contain any serious manufacturing errors. Finally, the IC products are finished and combined with the receiver to become the finalized receiver 103.

Please continue referring to FIG. 5. According to the preferred embodiment of the present invention, the process may combine a production planning procedure 104, which sets and/or expand the receiver's receiving mode through a software-stimulation programmer 50 (e.g. CPU), wherein the microprocessor 9 is used to receive and execute the programming commands input by the programmer 50, and save the programming commands to the memory 8.

Since the programmer 50 may set programming commands saved in the memory 8 directly, the receiving module corresponding to the programming commands can be obtained by simply setting the corresponding programming commands of the peripherals to the memory. The peripherals corresponding with the receiving modules could be a wireless keyboard, a wireless mouse, a wireless remote control, and any other wireless devices.

Hence with the corresponding programming command software of the peripherals, the user may repeatedly set and/or expand the receiving modules of the receiver 100.

In another preferred embodiment of the present invention, the programming command may be set to allow user to emulate a programmer by using certain programming command software on the host computer, and set the programming command corresponding to the peripheral in the receiver via USB. By doing so, the receiver may save various receiving modes with no interference and no waste of resources in the computer system.

The present invention provides an embodiment in the computer system to help the user operate and expand the software in the real-time interaction between the receiver and the user, so as to provide the user with various receiving modules. This helps the user achieve expandability and convenience while using peripherals.

Although the present invention has been described in considerable detail with reference to certain preferred embodiments thereof, those skilled in the art can easily understand that all kinds of alterations and changes can be made within the spirit and scope of the appended claims. Therefore, the spirit and scope of the appended claims should not be limited to the description of the preferred embodiments contained herein.

1. A programmable wireless receiver with receiving modes thereof being set and/or expanded by a software programmer, comprising;
a microprocessor used to receive and execute the programming commands input by the programmer; and
a memory connected to the microprocessor as a medium for accessing the programming commands.

2. The programmable wireless receiver as claimed in claim 1, wherein said memory is an EPROM.

3. The programmable wireless receiver as claimed in claim 1, wherein said programming commands correspond with the receiving modes of the peripherals.

4. The programmable wireless receiver as claimed in claim 1, wherein a USB is provided between said programmer and said receiver.

5. The programmable wireless receiver as claimed in claim 3 wherein said peripherals are wireless keyboards, wireless mice, or wireless remote controls.

6. The programmable wireless receiver as claimed in claim 1 wherein said programmer and said receiver further comprise a user interface to switch among the receiving modes of various peripherals.

7. The programmable wireless receiver as claimed in claim 1 wherein said user interface is a function menu.

8. A computer system used to program the receiving modules, comprising:
a programmer unit;
a programming circuit comprising a microprocessor and a memory, said microprocessor being used to receive and execute the programming commands input by the programmer, said memory being used as a medium for accessing the programming commands; and
a USB used as the interface for said programmer and said programmed circuit.
